(19) United States
(12) Patent Application Publication
(10) Pub. No.: US 2002/0002048 A1
(43) Pub. Date: Jan. 3, 2002

(54) Roaming in ATM network

(76) Inventor: Pasi Vaisanen, San Francisco, CA (US)

Correspondence Address: PILLSBURY WINTHROP LLP, 1600 TYSONS BOULEVARD, MCLEAN, VA, 22102, US

(21) Appl. No.: 09/879,832

(22) Filed: Jun. 13, 2001

Related U.S. Application Data
(63) Continuation of application No. PCT/FI00/00483, filed on May 30, 2000.

(30) Foreign Application Priority Data
May 31, 1999 (AU) PQ0661

(51) Int. Cl. H04Q 7/20

(52) U.S. Cl. 455/432; 455/433

(57) ABSTRACT

A method of implementing roaming in a system of fixed networks is disclosed. The method comprises performance of a roaming registration by the roaming user at a VLR, to whose area the roaming user has roamed, and a request, by the VLR, of a roaming user identity validation from an HLR associated with the roaming user. Thereafter, the HLR communicates a roaming user identity validation to the VLR, and updates a HLR database. The VLR also updates a VLR database. A connection establishment by at least one ATM switch between said roaming user and another user is managed by at least one of the VLR and the HLR.

This application is a Continuation of International Application PCT/FI00/00483 filed May 30, 2000 which designated the U.S. and was published under PCT Article 21(2) in English.

### FIELD OF INVENTION

This invention relates to the field of subscriber roaming in fixed packet networks, and in particular, networks based upon Asynchronous Transfer Mode (ATM) technology.

### BACKGROUND OF INVENTION

As telecommunications becomes a more pervasive tool in both business and social interaction, people require access to personalised telecommunications services wherever they go.

In fixed networks however, a subscriber is typically associated with a physically fixed network address. Furthermore, the particular communication services to which the subscriber is entitled are also associated with the same physical address.

Thus, a calling party A must use a known network address for a called party B to communicate with them. If the party B has roamed, i.e. moved, from that known address, the communication cannot be established, because party B from a network perspective, if not found at the aforementioned fixed address, is unreachable.

The object of the present invention is to at least ameliorate one or more disadvantages of the prior art.

### SUMMARY OF INVENTION

According to one aspect of the invention, there is provided a system implementing roaming of a roaming user in a coverage region associated with a fixed network, to which network at least a roaming user and another user are connected, the system comprising:

(a) a first Home Location Register (HLR), being associated with a first HLR area in said coverage region of the network, said HLR adapted (i) to receive an association registration from said roaming user, said roaming user being in said first HLR area, in order to establish an initial association with the roaming user, (ii) to output a roaming user identity validation in response to a request from a Visitor Location Register (VLR), and (iii) to update a first HLR database on the basis of at least one of a VLR address and a roaming user identity received from the VLR;

(b) the VLR, being associated with a VLR area in said coverage region of the network, said VLR adapted (i) to receive a roaming registration by the roaming user, and thereby to receive said roaming user identity, said roaming user having roamed into said VLR area, (ii) to request, as a response to said roaming registration, by communicating said roaming user identity and said VLR address to the HLR, at least the roaming user identity validation, (iii) to receive the roaming user identity validation from the HLR, and (iv) to update a VLR database on the basis of said roaming user identity validation; and

(c) a switch means responsive to one or more of the first HLR and the VLR, and adapted to establish a connection between said roaming user and said other user through the fixed network, said roaming user having roamed into the VLR area, and said other user being in a second HLR area associated with said second HLR, said establishment being dependent, in respect of the roaming user, upon at least the roaming user identity and said VLR address, and further dependent, in respect of the other user, upon an association registration with a second HLR.

According to a second aspect of the invention, there is disclosed a method implementing roaming in a coverage area associated with a fixed network, to which at least a roaming user and another user are connected, said network comprising at least (i) a switch, (ii) a first Home Location Register (HLR) associated with a first HLR area, said first HLR being associated with the roaming user by virtue of an association registration from said roaming user, and (iii) a Visitor Location Register (VLR) associated with a VLR area in said coverage region of the network, the method comprising the steps of:

(a) performing a roaming registration by the roaming user at the VLR, whereby the roaming user registers at least a roaming user identity and a first HLR address;

(b) requesting, by the VLR, at least a roaming user identity validation from the first HLR by communicating the roaming user identity and a VLR address to the first HLR;

(c) communicating at least a roaming user identity validation by the first HLR to the VLR;

(d) updating of a first HLR database by the first HLR on the basis of at least the VLR address;

(e) updating of a VLR database by the VLR on the basis of at least the identity validation; and

(f) controlling, by at least one of the VLR and the first HLR, a connection establishment between said roaming user and said other user through the network by the switch means, the roaming user being in the VLR area.

According to a third aspect of the invention, there is disclosed a Home Location Register (HLR) adapted for use in a system implementing roaming of a roaming user in a coverage region associated with a fixed network, to which network at least a roaming user and another user are connected, wherein said HLR is associated with an HLR area in said coverage region of the network, said HLR being adapted (i) to receive an association registration from said roaming user, said roaming user being in said HLR area, in order to establish an initial association with the roaming user, (ii) to output a roaming user identity validation in response to a request from a Visitor Location Register (VLR), and (iii) to update a first HLR database on the basis of at least one of a VLR address and a roaming user identity received from the VLR.

According to a fourth aspect of the invention, there is disclosed a Visitor Location Register (VLR), adapted for use in a system implementing roaming of a roaming user in a coverage region associated with a fixed network, to which network at least a roaming user and another user are connected, wherein said VLR is associated with a VLR area in said coverage region of the network, said VLR being adapted (i) to receive a roaming registration by the roaming user, and thereby to receive a roaming user identity, said roaming user having roamed into said VLR area, (ii) to request, as a response to said roaming registration, by communicating said roaming user identity and a VLR address to the HLR, at least the roaming user identity validation, (iii) to receive the roaming user identity validation from the HLR, and (iv) to update a VLR database on the basis of said roaming user identity validation.

According to a fifth aspect of the invention, there is disclosed a switch means, adapted for use in a system implementing roaming of a roaming user in a coverage region associated with a fixed network, to which network at least a roaming user and another user are connected, wherein said switch means is responsive to one or more of a first HLR and a VLR, and is adapted to establish a connection between said roaming user and said other user through the fixed network, said roaming user having roamed into the VLR area, and said other user being in a second HLR area associated with a second HLR, said establishment being dependent, in respect of the roaming user, upon at least a roaming user identity and a VLR address, and further dependent, in respect of the other user, upon an association registration with said second HLR.

### BRIEF DESCRIPTION OF THE DRAWINGS

An embodiment of the invention is described with reference to the drawings, in which:

FIG. 1 depicts a preferred embodiment of a network architecture which supports subscriber roaming;

FIG. 2 depicts a cell structure for ATM traffic;

FIG. 3 illustrates a registration process in the preferred embodiment for a subscriber A;

FIG. 4 illustrates a registration procedure in the preferred embodiment for the subscriber A when the terminal equipment is located at a home location;

FIG. 5 depicts a registration process in the preferred embodiment for the subscriber A when the subscriber equipment is visiting at another location;

FIG. 6 depicts a process in the preferred embodiment whereby a calling party B initiates communication with the subscriber A using an HLR address for A;

FIG. 7 depicts a process in the preferred embodiment whereby a calling party B initiates communication with the subscriber A using a home address for A;

FIG. 8 shows communication in the preferred embodiment from the calling party B to the called party A when the called party A is at a home location; and

FIG. 9 shows communication in the preferred embodiment between the calling party B and the called party A when the called party A is visiting at another location.

### DETAILED DESCRIPTION INCLUDING BEST MODE

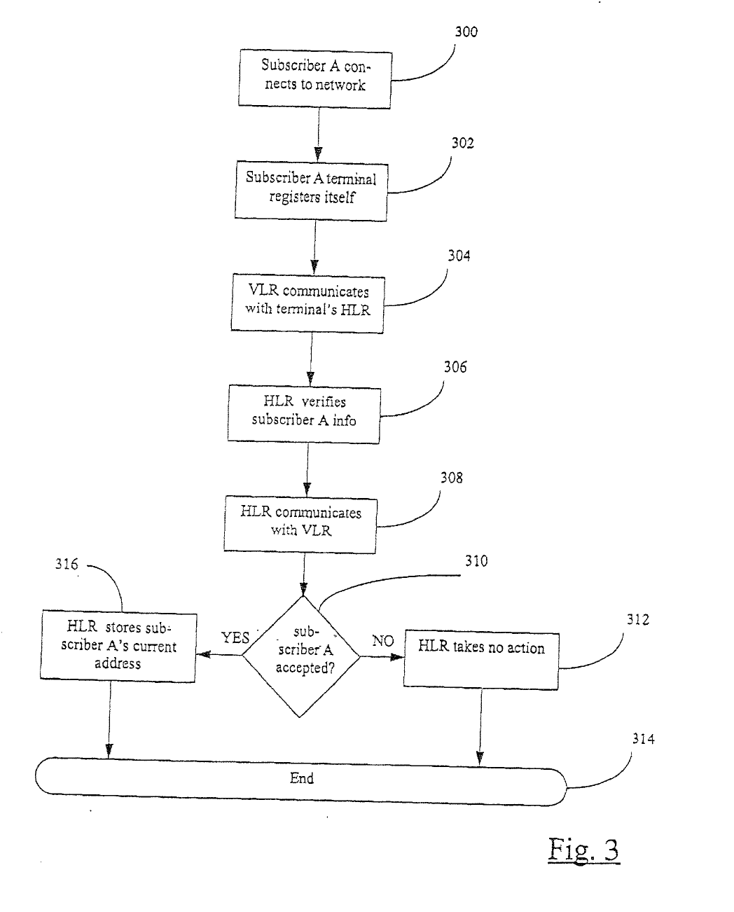

The phrases “the subscriber” and “the network terminal equipment associated with the subscriber” are used interchangeably in the specification unless specified otherwise. Thus, for example, FIG. 3 depicts a registration process for the network terminal equipment associated with a subscriber A, however for ease of understanding, the description is provided in terms of a registration process for the subscriber A.

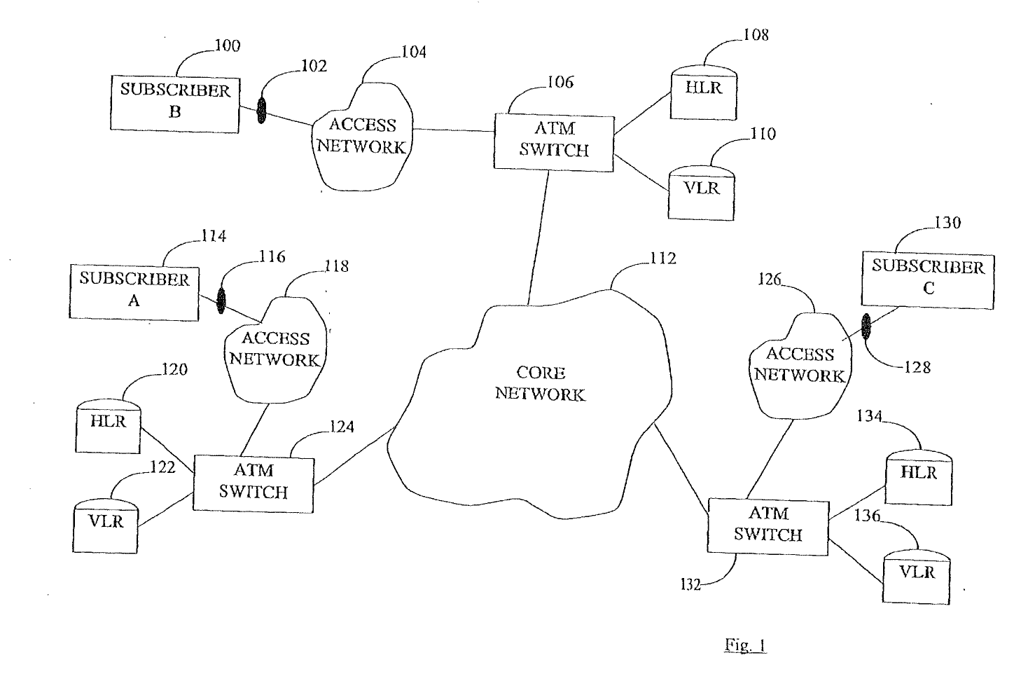

FIG. 1 depicts a network architecture based on ATM technology which can support subscriber roaming. A first subscriber 100 (i.e. subscriber B) is connected by means of an access port 102 to an access network 104, which in turn is connected through an ATM switch 106 to a core network 112. The access network 104 typically provides an access medium for subscribers, exemplified by the subscriber “B” 100, who are physically located in the same geographic area. The core network 112 on the other hand serves to interconnect different access networks 104, 118, 126, thus providing extended geographic coverage. The ATM switch 106 is also connected to a Home Location Register (HLR) 108 and a Visitors Location Register (VLR) 110. A second subscriber 114 (i.e. subscriber A) is connected by means of an access port 116 to the second access network 118. This second access network 118 is connected to a second ATM switch 124. The second ATM switch 124 is connected to the core network 112, and is also connected to a second HLR 120, and a second VLR 122. A third subscriber 130 (i.e. subscriber C) is connected by means of an access port 128 to the third access network 126, which is connected to a third ATM switch 132, and in turn to the core network 112. The third ATM switch 132 is connected to a third HLR 134 and a third VLR 136.

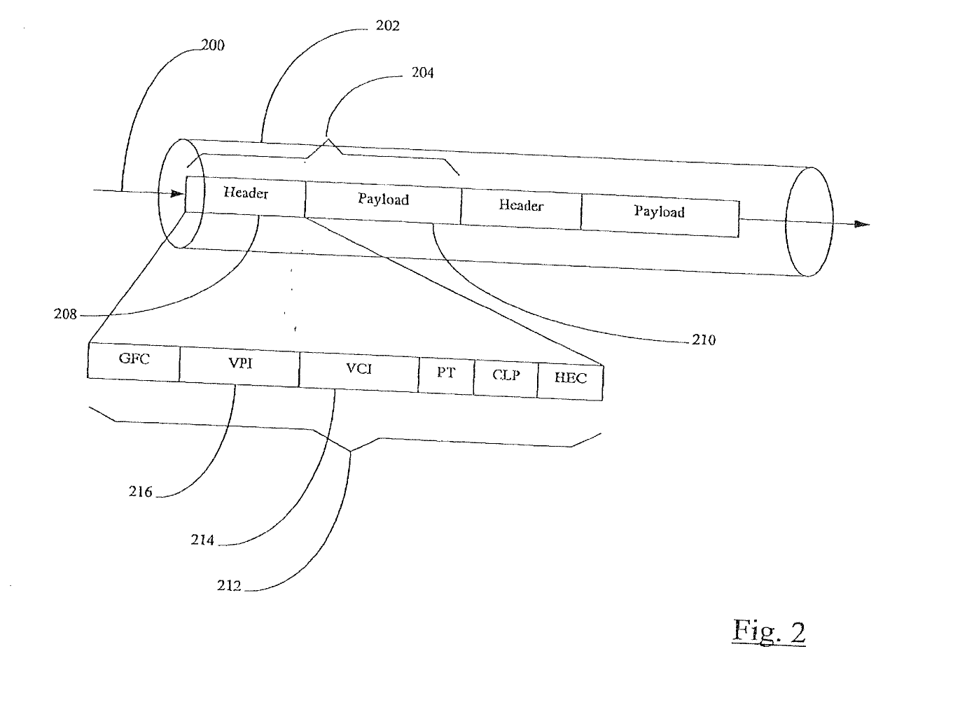

FIG. 2 shows a structure of an ATM traffic stream 200. The ATM traffic stream 200 is transported on a transmission path 202, and the traffic stream 200 is seen to comprise cells 204 where each cell 204 consists of a header 208 and a payload 210. The header 208 is shown in more detail in an inset 212. ATM standards define a fixed-size cell 204 having a length of 53 octets (or bytes), comprising a 5-octet header 208 and a 48-octet payload 210. Individual bits in a cell 204 are transmitted over the transmission path 202 in a continuous stream from left to right as shown by the arrow 200. The cell header 208 identifies a destination for the cell 204. A Virtual Path Identifier 216 (VPI) and a Virtual Channel Identifier 214 (VCI) have local addressing significance only, and identify the destination of the cell 204 in a local context.

FIG. 3 shows a registration process for a subscriber A in the preferred embodiment. In general, it is noted that when a subscriber initially registers with a telecommunication service provider in relation to a roaming service, the subscriber is associated with a specific HLR, usually being at the home location area of the subscriber. Each such local area will typically, although not necessarily have associated with it an HLR, and in addition a VLR. The VLR serves as a temporary database for storing information regarding subscribers visiting the area. After the subscriber A connects to a network according to a process step 300, a process step 302 indicates that the network terminal equipment associated with the subscriber A registers itself. The registration procedure involves sending a user identification code for the subscriber A, and also the network address of the HLR associated with the subscriber A, to a local VLR in the area where the subscriber A is presently registering. The VLR can incorporate a firewall to filter incoming messages. The message filtering can perform one of several functions, including signalling traffic control in order to limit the amount of signalling traffic in the network, and for security purposes, in order to safeguard data in the VLR. Thereafter, in a process step 304, the VLR sends a message containing the aforementioned information to the HLR associated with the subscriber A. It is noted that the HLR contains a current address for the subscriber A, and also contains the user identity, account information and a description of which services the subscriber A is entitled to access. Thereafter, in a process 306, the HLR authenticates the subscriber A identity as contained in the VLR message against the user identity information which is stored locally, and also retrieves the information describing which services the subscriber A is entitled to access. Moving to a process step 308, the HLR communicates with the VLR, by sending an acknowledgment or a reject message. An acknowledgment message is sent in the event that the HLR validates that subscriber A is an authorised subscriber. Moving to a process step 310, if the subscriber A has been accepted, then the registration process is directed to a process step 316, where the HLR stores an updated current address of the subscriber A into the HLR database. The aforementioned updated current address was included in the message from the VLR, as described in the process step 304. Alternatively, if the subscriber A is rejected, the registration process is directed to a process step 312 which indicates that the HLR takes no action. After the subscriber A is either accepted or rejected, the registration process terminates at a process step 314.

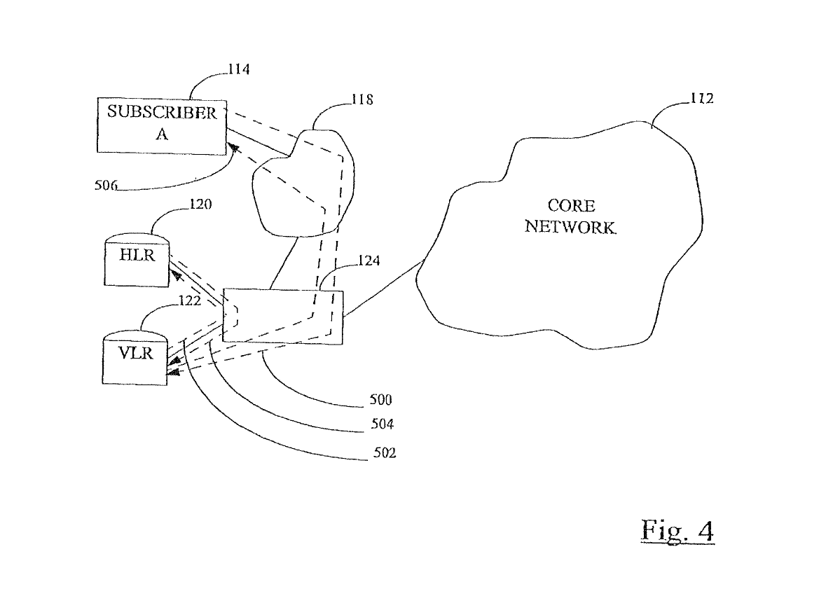

FIG. 4 depicts a registration procedure when the subscriber A is located in a usual home location. The terminal equipment 114 associated with the subscriber A sends identification and address information to a VLR 122 as shown by a dashed line 500. The VLR 122 initiates an inquiry 502 to an HLR 120, this HLR having been designated as the HLR associated with the subscriber A. The HLR 120 returns information about the subscriber A to the VLR 122 as depicted by a dashed line 504, and stores an address of the VLR 122 into a database in the HLR 120. Finally, the terminal 114 is accepted by the VLR 122, this acceptance being communicated by the VLR 122 as depicted by a dashed line 506 to the terminal 114.

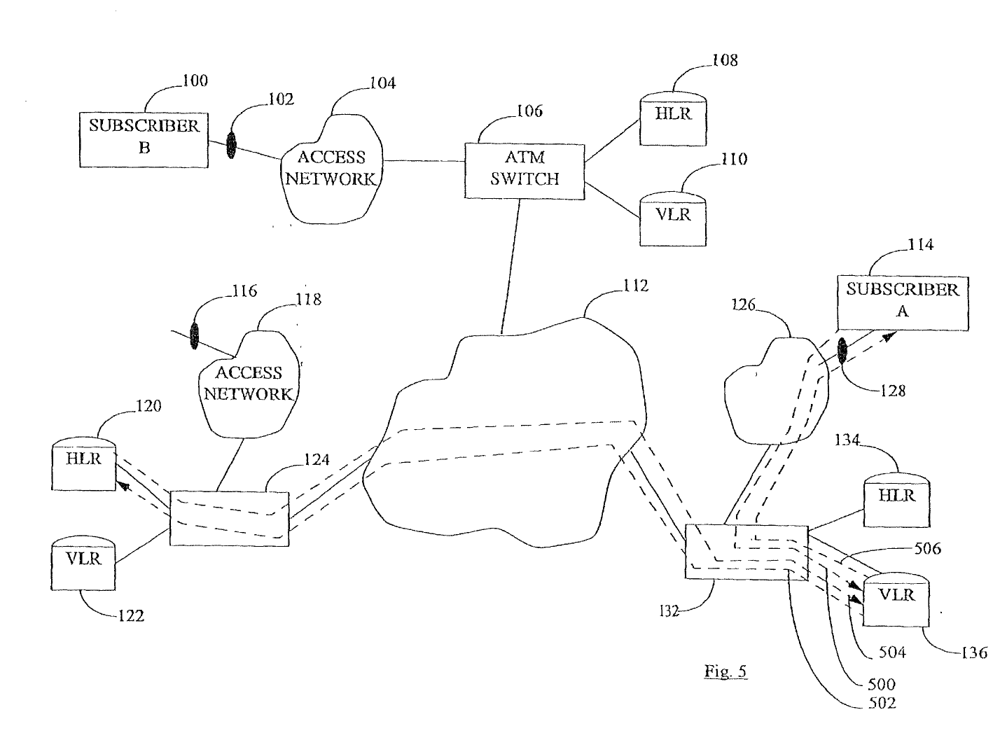

FIG. 5 depicts a registration procedure when the terminal 114 associated with the subscriber A is in a visiting location. In FIG. 5, the terminal 114 is normally resident at a port 116 associated with the access network 118. The terminal 114 has, in this case however, roamed to a port 128 which is associated with a different access network 126. The terminal 114 registers with a local VLR 136 as depicted by a dashed line 500. This registration procedure involves sending identification information, an address for the HLR 120 which is normally associated with the terminal 114 and other information. The VLR 136 sends an inquiry to the HLR 120 which is associated with the terminal 114, this inquiry depicted by a dashed line 502. The HLR 120 returns authentication and service information associated with the terminal 114 back to the VLR 136 as indicated by a dashed line 504, and the HLR 120 further registers a visiting address associated with the VLR 136 into a database in the HLR 120. Finally, the terminal 114 is accepted by the VLR 136, this acceptance being communicated to the terminal 114 as depicted by a dashed line 506. In addition to communicating the acceptance to the terminal 114, an address for the terminal 114 is flagged as active in a database in the VLR 136. This flag signifies that communication can be initiated with the terminal 114.

The aforementioned description in relation to FIGS. 3 to 5 describe how a terminal 114 registers its presence in a network, the registration taking place either at a home location for the terminal, or at a visitor location to which a terminal has roamed.

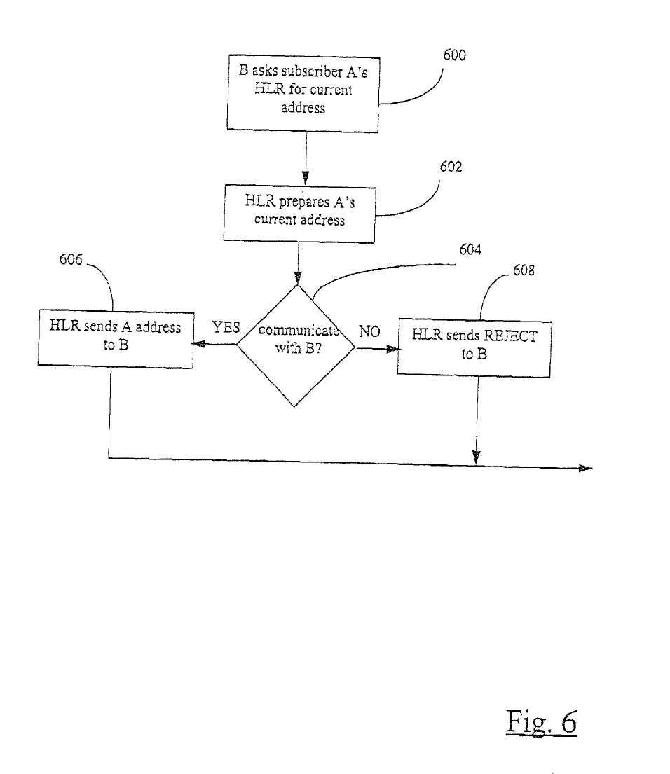

FIG. 6 depicts a process whereby a second party i.e. subscriber B initiates communication with the first party i.e. subscriber A. When the subscriber B, wishes to communicate with the subscriber A, the subscriber B sends an inquiry to the subscriber A's HLR in order to obtain the subscriber A's current address, this being shown in a process step 600. After receiving the inquiry, the HLR prepares and returns a current address for the subscriber A to the subscriber B in a process step 602. In addition to providing a current address for the subscriber A, the HLR can also consider whether additional services are to be provided to the subscriber A. For example, the subscriber A may have elected to accept communication from certain parties, while rejecting it from others. If, for example, communications with the subscriber B are permitted, then the HLR will return a current address for the subscriber A in response to the enquiry from the subscriber B. Alternatively, if communications with subscriber B are not permitted, a reject message is sent to the subscriber B. The aforementioned “call filter” procedure is performed by a process step 604. If communication with the subscriber B is allowed, the HLR accepts communication with subscriber B in a process step 606, thereafter sending a current address for the subscriber A to the subscriber B. In the event that communication with the subscriber B is not permitted, the HLR will sent a reject message to the subscriber B, as shown in a process step 608.

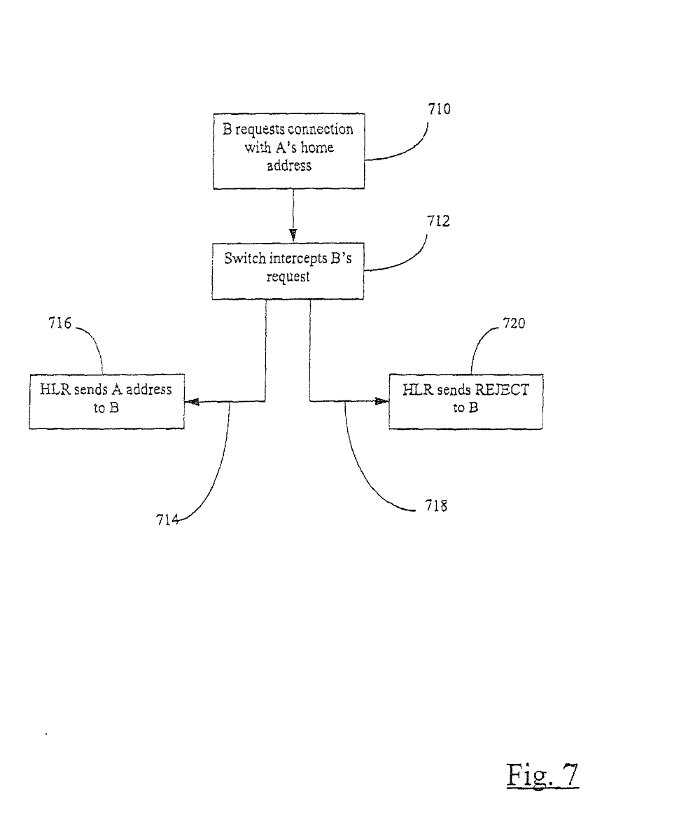

FIG. 7 depicts an alternate process whereby a second party, ie. subscriber B, initiates communication with the first party, ie. subscriber A. In the aforementioned process in relation to FIG. 6, the subscriber B has to have knowledge of the HLR associated with the subscriber A, whereas in the present embodiment, the subscriber B attempts to establish a connection with the subscriber A by using the home address for subscriber A, as shown in process step 710. Thereafter, a switch to which subscriber A is normally connected intercepts the connection request from subscriber B, as shown in process step 712. Following this step, the embodiment may be implemented in one of two ways. In a first option, as indicated by arrow 714, the aforementioned switch supplies a current address for the subscriber A to the subscriber B as shown in a process step 716. In an alternate option, as shown by an arrow 718, the aforementioned switch directly controls network signalling to one or more network switches, in order to establish the connection between subscribers A and B, as shown in a process step 720.

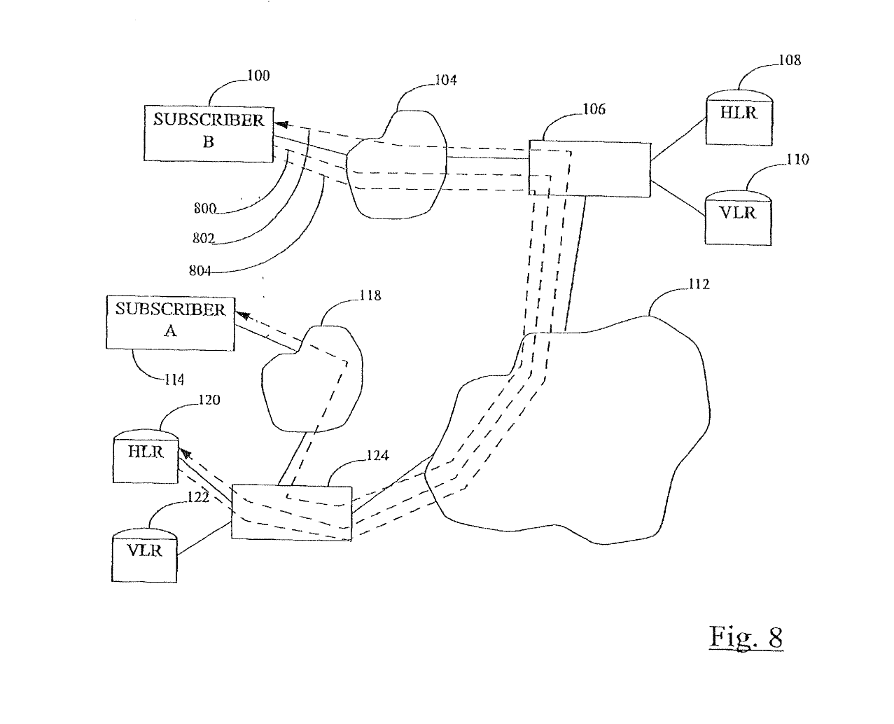

FIG. 8 depicts communication from the subscriber B (ie. 100) to the subscriber A (ie. 114) when the subscriber A (ie. 114) is at the usual home location for subscriber A. The subscriber B 100 sends an inquiry to the HLR 120 for the subscriber A 114 as depicted by a dashed line 800. The HLR 120 returns a current address for the subscriber A 114 to the subscriber B 100 as indicated by a dashed line 802. It is noted in FIG. 8 that the subscriber A is currently at a home location, and thus the current address which is returned to the subscriber B 100 will be the home address for the subscriber A. Having received a current address for the subscriber A 114, the subscriber B 100 is now able to communicate directly to the subscriber A 114 as illustrated by a dashed line 804.

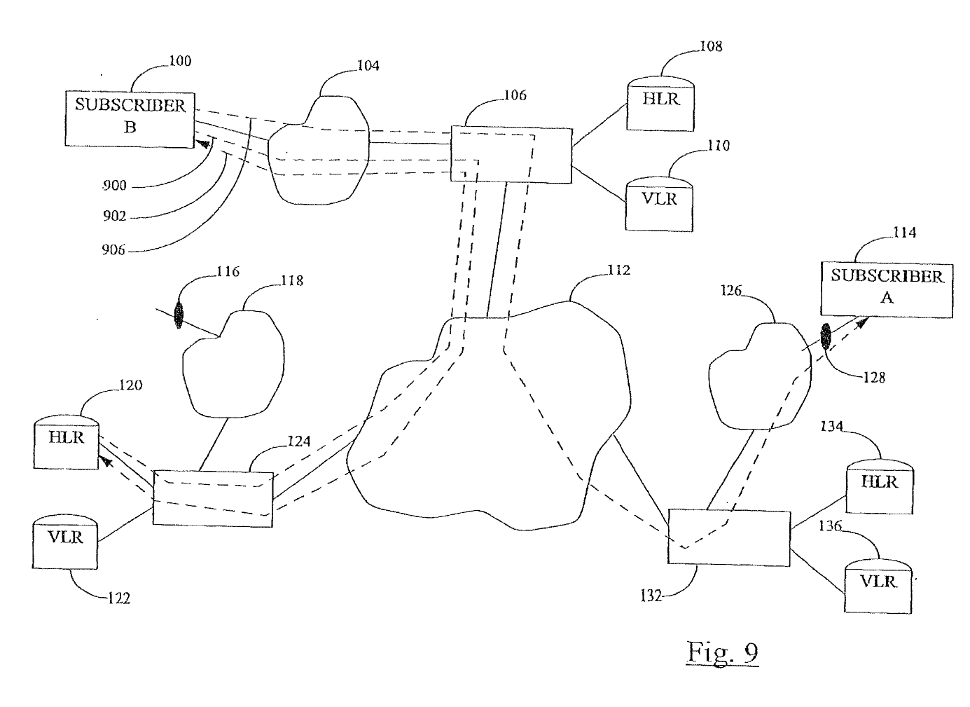

FIG. 9 depicts a communication process between the subscriber B 100 and the subscriber A 114 in the event that the subscriber A 114 has roamed away from its home address. The subscriber B 100 sends an inquiry to the HLR 120 which is associated with the home address for the subscriber A 114, this inquiry being depicted by a dashed line 900. The HLR 120 returns a current address for the subscriber A 114 to the subscriber B 100, this communication being depicted by a dashed line 902. Now that the subscriber B 100 has a current address for the subscriber A 114, the subscriber B 100 is able to communicate directly with the subscriber A 114 as depicted by a dashed line 906.

Industrial Applicability

It is apparent from the above that the embodiments of the invention are applicable to the telecommunications industry.

The foregoing describes only a particular embodiment of the present invention, and modifications can be made thereto without departing from the scope of the invention.

1. A system implementing roaming of a roaming user in a coverage region associated with a fixed network, to which network at least a roaming user and another user are connected, the system comprising:
(a) a first Home Location Register (HLR), being associated with a first HLR area in said coverage region of the network, said HLR adapted (i) to receive an association registration from said roaming user, said roaming user being in said first HLR area, in order to establish an initial association with the roaming user, (ii) to output a roaming user identity validation in response to a request from a Visitor Location Register (VLR), and (iii) to update a first HLR database on the basis of at least one of a VLR address and a roaming user identity received from the VLR;
(b) the VLR, being associated with a VLR area in said coverage region of the network, said VLR adapted (i) to receive a roaming registration by the roaming user, and thereby to receive said roaming user identity, said roaming user having roamed into said VLR area, (ii) to request, as a response to said roaming registration, by communicating said roaming user identity and said VLR address to the HLR, at least the roaming user identity validation, (iii) to receive the roaming user identity validation from the HLR, and (iv) to update a VLR database on the basis of said roaming user identity validation; and
(c) a switch means responsive to one or more of the first HLR and the VLR, and adapted to establish a connection between said roaming user and said other user through the fixed network, said roaming user having roamed into the VLR area, and said other user being in a second HLR area associated with said second HLR, said establishment being dependent, in respect of the roaming user, upon at least the roaming user identity and said VLR address, and further dependent, in respect of the other user, upon an association registration with a second HLR.

2. A system according to claim 1, comprising:
at least a first and a second said fixed network, each being an access network, each said access network comprising respective said first and second HLRs, said VLR, and said switch; wherein said roaming user has roamed to said VLR area in said first fixed network, and said other user is in said second HLR area in said second network; and
a core network providing connectivity necessary to support said connection between said roaming user and said other user.

3. A method implementing roaming in a coverage area associated with a fixed network, to which at least a roaming user and another user are connected, said network comprising at least (i) a switch, (ii) a first Home Location Register (HLR) associated with a first HLR area, said first HLR being associated with the roaming user by virtue of an association registration from said roaming user, and (iii) a Visitor Location Register (VLR) associated with a VLR area in said coverage region of the network, the method comprising the steps of:
(a) performing a roaming registration by the roaming user at the VLR, whereby the roaming user registers at least a roaming user identity and a first HLR address;
(b) requesting, by the VLR, at least a roaming user identity validation from the first HLR by communicating the roaming user identity and a VLR address to the first HLR;
(c) communicating at least a roaming user identity validation by the first HLR to the VLR;
(d) updating of a first HLR database by the first HLR on the basis of at least the VLR address;
(e) updating of a VLR database by the VLR on the basis of at least the identity validation; and
(f) controlling, by at least one of the VLR and the first HLR, a connection establishment between said roaming user and said other user through the network by the switch means, the roaming user being in the VLR area.

4. A Home Location Register (HLR) adapted for use in a system implementing roaming of a roaming user in a coverage region associated with a fixed network, to which network at least a roaming user and another user are connected, wherein said HLR is associated with an HLR area in said coverage region of the network, said HLR being adapted (i) to receive an association registration from said roaming user, said roaming user being in said HLR area, in order to establish an initial association with the roaming user, (ii) to output a roaming user identity validation in response to a request from a Visitor Location Register (VLR), and (iii) to update a first HLR database on the basis of at least one of a VLR address and a roaming user identity received from the VLR.

5. A Visitor Location Register (VLR), adapted for use in a system implementing roaming of a roaming user in a coverage region associated with a fixed network, to which network at least a roaming user and another user are connected, wherein said VLR is associated with a VLR area in said coverage region of the network, said VLR being adapted (i) to receive a roaming registration by the roaming user, and thereby to receive a roaming user identity, said roaming user having roamed into said VLR area, (ii) to request, as a response to said roaming registration, by communicating said roaming user identity and a VLR address to the HLR, at least the roaming user identity validation, (iii) to receive the roaming user identity validation from the HLR, and (iv) to update a VLR database on the basis of said roaming user identity validation.

6. A switch means, adapted for use in a system implementing roaming of a roaming user in a coverage region associated with a fixed network, to which network at least a roaming user and another user are connected, wherein said switch means is responsive to one or more of a first HLR and a VLR, and is adapted to establish a connection between said roaming user and said other user through the fixed network, said roaming user having roamed into the VLR area, and said other user being in a second HLR area associated with a second HLR, said establishment being dependent, in respect of the roaming user, upon at least a roaming user identity and a VLR address, and further dependent, in respect of the other user, upon an association registration with said second HLR.
